(19) United States
(12) Patent Application Publication
(10) Pub. No.: US 2011/0209996 A1
(43) Pub. Date: Sep. 1, 2011

(54) Electrochemical sensor

(76) Inventors: Tai-Ping Sun, Jhongli City (TW); Chung-Yuan Chen, Sinhua Township (TW); Hsiu-Li Shieh, Taichung City (TW); Tak-Shing Ching, Taichung City (TW)

(21) Appl. No.: 12/805,888

(22) Filed: Aug. 23, 2010

(30) Foreign Application Priority Data
Feb. 26, 2010 (TW) 099105632

(51) Int. Cl. G01N 27/26

(52) U.S. Cl. 204/412; 204/416

(57) ABSTRACT

An electrochemical sensor for detecting the concentration of ions in a solution includes a substrate, a sensor unit, and a reference electrode. The sensor unit includes at least one working electrode. The working electrode has a conductive layered structure formed on the substrate, and a sensor element of a metal oxide film formed on the conductive layered structure and capable of reacting with the ions in the solution to generate a potential. The reference electrode is spaced apart from the working electrode, and includes a conductive film printed on the substrate for establishing a potential difference between the working electrode and the reference electrode when the electrochemical sensor is brought into contact with the solution.

### CROSS-REFERENCE TO RELATED APPLICATION

This application claims priority of Taiwanese Application No. 099105632, filed on Feb. 26, 2010.

### BACKGROUND OF THE INVENTION

1. Field of the Invention

This invention relates to an electrochemical sensor, more particularly to an electrochemical sensor including a substrate formed with a reference electrode and a working electrode thereon.

2. Description of the Related Art

U.S. Patent Application Publication no. 2009/0021263 discloses an electrochemical system that includes a multi-ion potential sensor and a solid-state reference electrode. As illustrated in FIG. 1, the multi-ion potential sensor includes a substrate 100, a conductive layer 104, a SnO₂ layer 120, a selective layer 122, and an isolation layer 130. The conductive layer 104 has conductive elements 110 mounted on the substrate 100. Each of the conductive elements 110 has a readout part 112, a transmissive part 114, and a sensing part 116. The SnO₂ layer 120 has a plurality of SnO₂ pads 120′, which are mounted on the sensing parts 116 of respective ones of the conductive elements 110 so as to form working electrodes. The selective layer 122 has a plurality of selective areas 122′, which are mounted on the SnO₂ pads 120′, respectively. As illustrated in FIG. 2, the solid-state reference electrode includes an Ag body 182 connected to a wire 190, an AgCl layer 184 enclosing the Ag body 182, a polymer 186 enclosing the AgCl layer 184, and an insulator 188 shielding an end of the wire 190 that is connected to the Ag body 182. In operation, the multi-ion potential sensor and the solid-state reference electrode are separately placed in a solution containing ions, the concentration of which is to be measured, and are coupled to a meter (not shown) which generates an output signal corresponding to the concentration of the ions in the solution, thereby permitting determination of the concentration of the ions in the solution.

### SUMMARY OF THE INVENTION

An object of the present invention is to provide an electrochemical sensor including a working electrode and a reference electrode which are formed on a substrate and which cooperate with each other to provide satisfactory sensitivity and linearity in detection of the concentration of ions of interest in a solution.

According to this invention, there is provided an electrochemical sensor for detecting the concentration of ions in a solution. The electrochemical sensor includes a substrate, a sensor unit, and a reference electrode. The sensor unit includes at least one working electrode. The working electrode has a conductive layered structure formed on the substrate, and a sensor element of a metal oxide film formed on the conductive layered structure and capable of reacting with the ions in the solution to generate a potential. The reference electrode is spaced apart from the working electrode and includes a conductive film printed on the substrate for establishing a potential difference between the working electrode and the reference electrode when the electrochemical sensor is brought into contact with the solution.

### BRIEF DESCRIPTION OF THE DRAWINGS

Other features and advantages of the present invention will become apparent in the following detailed description of the preferred embodiments of this invention, with reference to the accompanying drawings, in which:

FIG. 1 is an exploded perspective view illustrating the configuration of a conventional multi-ion potential sensor;

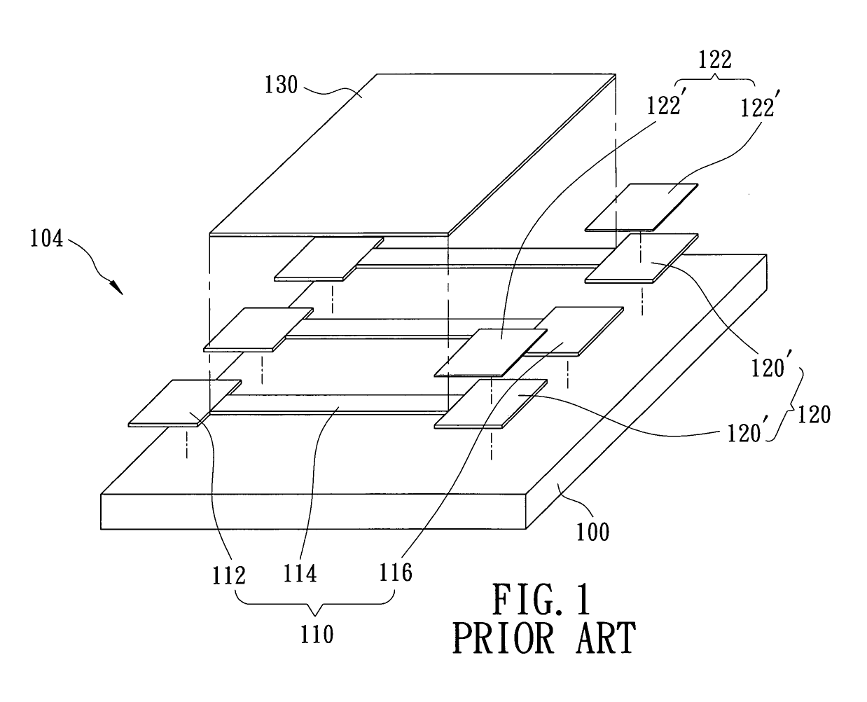

FIG. 2 is a schematic side view illustrating the configuration of a conventional solid-state reference electrode;

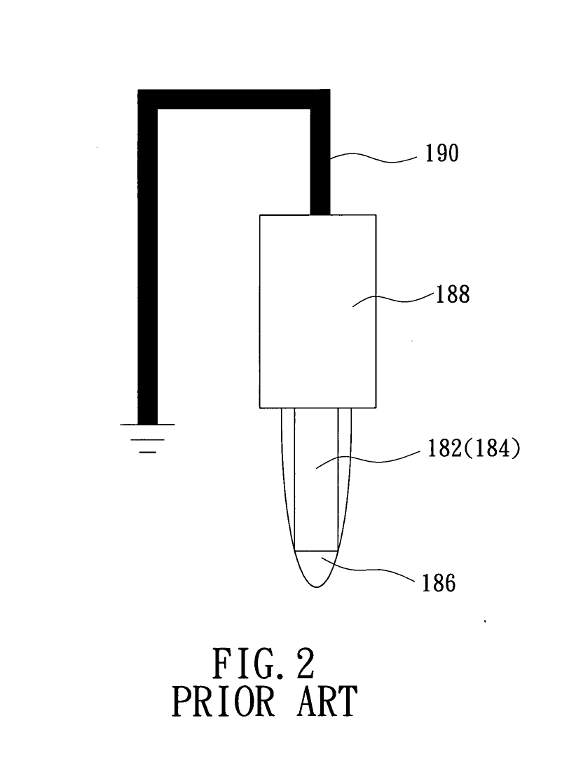

FIG. 3 is a perspective view of the first preferred embodiment of an electrochemical sensor according to this invention;

FIG. 4 is a schematic top view of the second preferred embodiment of the electrochemical sensor according to this invention;

FIG. 5 is a schematic top view of the third preferred embodiment of the electrochemical sensor according to this invention;

FIG. 6 is a schematic top view of the fourth preferred embodiment of the electrochemical sensor according to this invention;

FIG. 7 is a schematic top view of the fifth preferred embodiment of the electrochemical sensor according to this invention;

FIG. 8 is an exploded perspective view of the sixth preferred embodiment of the electrochemical sensor according to this invention;

FIG. 9 is an exploded perspective view of the seventh preferred embodiment of the electrochemical sensor according to this invention;

FIG. 10 shows schematic views to illustrate consecutive steps of a process of forming the seventh preferred embodiment of the electrochemical sensor;

FIG. 11 is a schematic view illustrating the use of the seventh preferred embodiment in a measuring system for measuring ions in a solution; and

FIG. 12 is a schematic view illustrating the use of the conventional multi-ion potential sensor and the reference electrode in a measuring system for measuring ions in a solution.

### DETAILED DESCRIPTION OF THE PREFERRED EMBODIMENTS

Before this invention is described in greater detail with reference to the accompanying preferred embodiments, it should be noted herein that like elements are denoted by the same reference numerals throughout the disclosure.

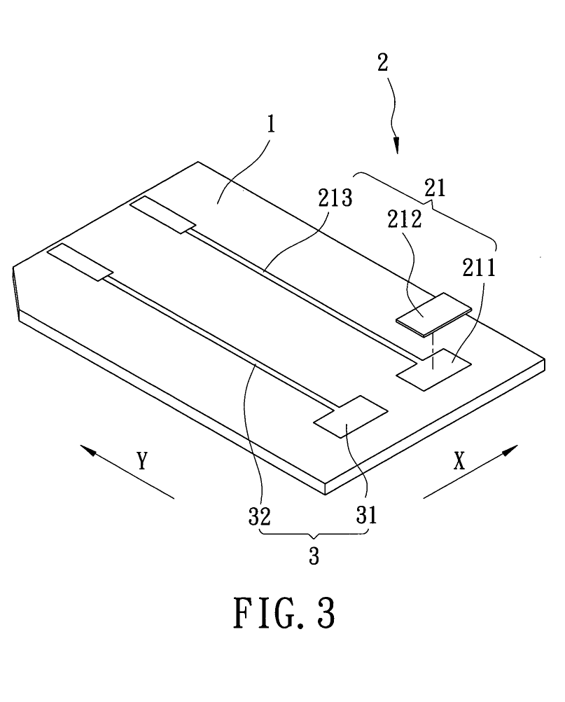

Referring to FIG. 3, the first preferred embodiment of the electrochemical sensor for detecting the concentration of ions in a solution according to this invention includes a substrate 1, a sensor unit 2, and a reference electrode 3. The sensor unit 2 includes a working electrode 21. The working electrode 21 has a conductive layered structure 211 formed on the substrate 1, a sensor element 212 of a conductive metal oxide film formed on the conductive layered structure 211 and capable of reacting with the ions in the solution to generate a potential, and a conductive trace 213 printed on the substrate 1 and extending from the conductive layered structure 211 of the working electrode 21. The reference electrode 3 is spaced apart from the working electrode 21 in a first direction (X), and includes a conductive film 31 printed on the substrate 1 and a reference conductive trace 32 printed on the substrate 1. The conductive film 31 is used for establishing a potential difference between the working electrode 21 and the reference electrode 3 when the electrochemical sensor is brought into contact with the solution, such as by immersing in a container that holds the solution. The reference conductive trace 32 extends from the conductive film 31 along a second direction (Y) transverse to the first direction (X). The conductive trace 213 also extends along the second direction (Y). In this embodiment, the conductive film 31 of the reference electrode 3 is bar-like in shape and extends in the first direction (X). The sensor element 212 of the working electrode 21 is disposed adjacent to the conductive film 31.

The conductive film 31 of the reference electrode 3 is made from a material selected from the group consisting of iron, copper, carbon, silver, silver chloride, indium tin oxide, zinc and tin. Preferably, the conductive film 31 is made from silver paste. Alternatively, the conductive film 31 of the reference electrode 3 may include a first layer of silver paste printed on the substrate 1, a second layer of carbon paste printed on the first layer, and a third layer of silver paste printed on the second layer.

The conductive layered structure 211 of the working electrode 21 includes at least one layer made from a material selected from the group consisting of iron, copper, carbon, silver, silver chloride, indium tin oxide, zinc and tin. Preferably, the conductive layered structure 211 includes a layer of silver paste. Alternatively, the conductive layered structure 211 may include a first layer of silver paste printed on the substrate 1, and a second layer of carbon paste printed on the first layer. The sensor element 212 is formed on the second layer.

Preferably, the metal oxide for forming the sensor elements 212 is tin oxide.

The conductive trace 213 of the working electrode 21 is used to electrically connect the conductive layered structure 211 to a measuring system (not shown). The reference conductive trace 32 is used to electrically connect the conductive film 31 of the reference electrode 3 to the measuring system.

The conductive trace 213 of the working electrode 21 and the reference conductive trace 32 of the reference electrode 3 include at least one layer made from a material selected from the group consisting of iron, copper, carbon, silver, silver chloride, indium tin oxide, zinc and tin. Preferably, the conductive trace 213 of the working electrode 21 and the reference conductive trace 32 of the reference electrode 3 are made from silver paste. Alternatively, the conductive trace 213 of the working electrode 21 and the reference conductive trace 32 of the reference electrode 3 may include a first layer of silver paste printed on the substrate 1, a second layer of carbon paste printed on the first layer, and a third layer of silver paste printed on the second layer.

The substrate 1 may be made from a flexible and insulating material, such as polyethylene terephthalate.

The number of the working electrodes 21 may be changed according to requirements of the actual application.

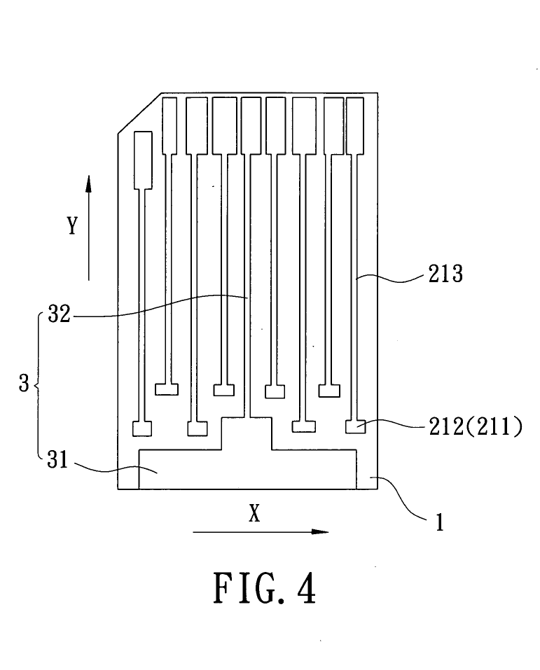

FIG. 4 illustrates a configuration of the second preferred embodiment of the electrochemical sensor according to this invention. The configuration of the second preferred embodiment is similar to that of the first preferred embodiment, except that, in the second preferred embodiment, the sensor unit 2 includes eight working electrodes 21. The sensor elements 212 of the working electrodes 21 are disposed adjacent to the conductive film 31 and are arranged into two groups (or rows) such that the sensor elements 212 of each group are distributed along the first direction (X).

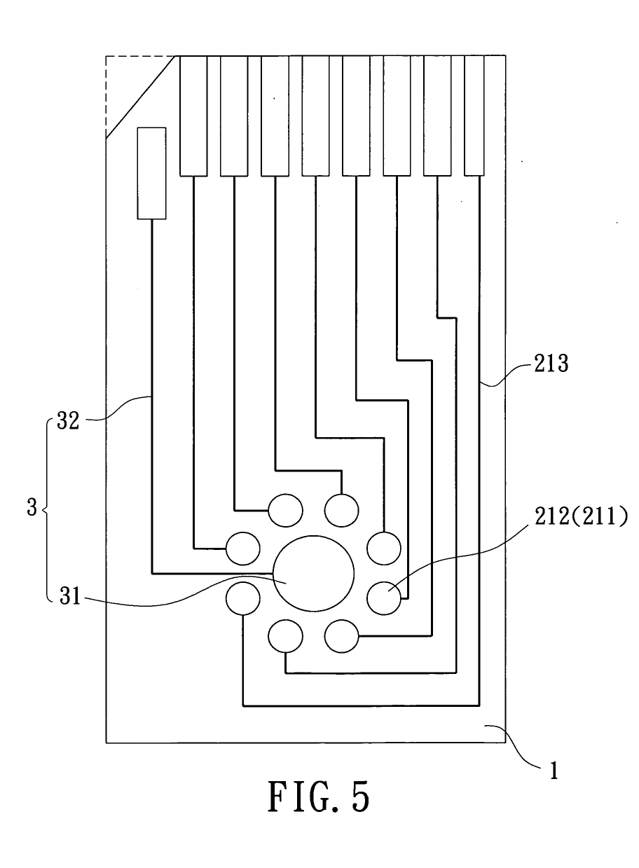

Referring to FIG. 5, the configuration of the third preferred embodiment of the electrochemical sensor according to this invention is similar to the second preferred embodiment, except that, in the third preferred embodiment, the conductive film 31 of the reference electrode 3 is circular in shape, and the sensor elements 212 of the working electrodes 21 are circular in shape and are angularly displaced from one another to surround the conductive film 31.

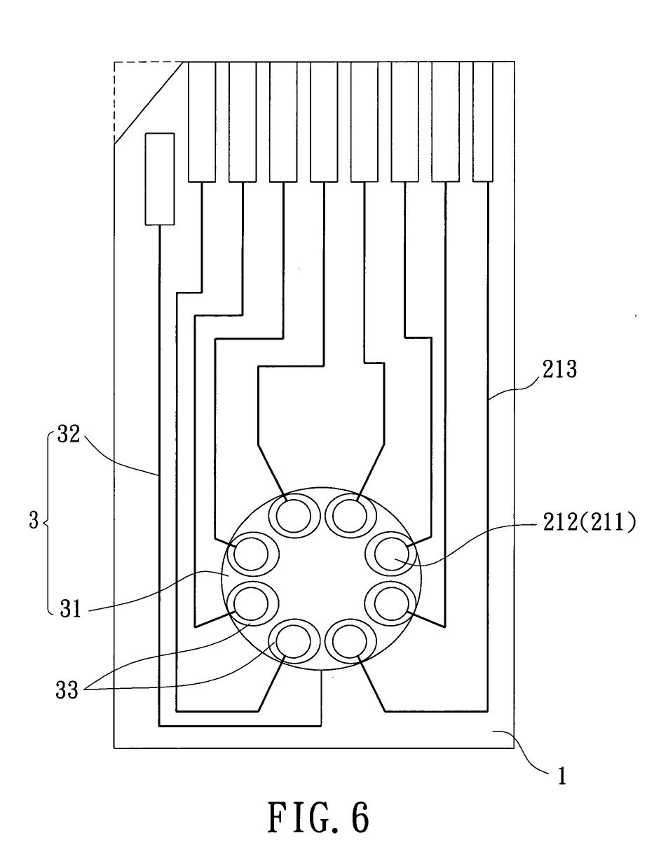

Referring to FIG. 6, the configuration of the fourth preferred embodiment of the electrochemical sensor according to this invention is similar to the second preferred embodiment, except that, in the fourth preferred embodiment, the conductive film 31 of the reference electrode 3 is circular in shape and is formed with eight inner spaces 33 that are angularly displaced from one another, and the sensor elements 212 of the working electrodes 21 are disposed in the inner spaces 33, respectively.

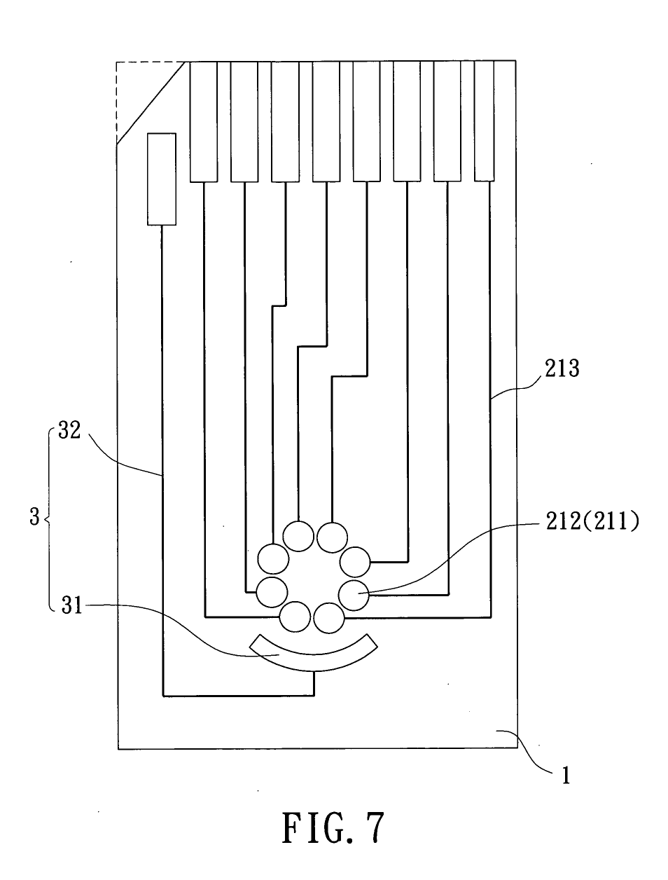

Referring to FIG. 7, the configuration of the fifth preferred embodiment of the electrochemical sensor according to this invention is similar to the second preferred embodiment, except that, in the fifth preferred embodiment, the conductive film 31 of the reference electrode 3 is arch-like in shape, and the sensor elements 212 of the working electrodes 21 are circular in shape and are angularly displaced from one another.

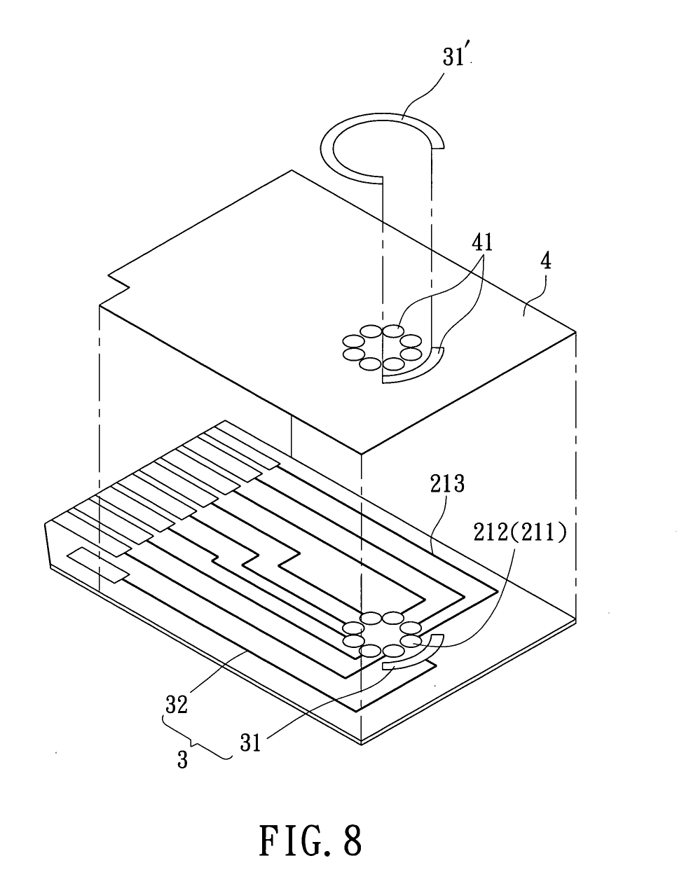

Referring to FIG. 8, the configuration of the sixth preferred embodiment of the electrochemical sensor according to this invention is similar to the fifth preferred embodiment, except that, in the sixth preferred embodiment, the electrochemical sensor further includes an insulating film 4 formed with through-holes 41 for covering the conductive traces 213 of the working electrodes 21 and the reference conductive trace 32 of the reference electrode 3 and for exposing the conductive film 31 of the reference electrode 3 and the sensor elements 212 of the working electrodes 21 from the insulating film 4. The electrochemical sensor further includes a circumferentially extending conductive film 31′ that is printed on the insulating film 4, that is connected to the conductive film 31 of the reference electrode 3, and that is disposed around the sensor elements 212 of the working electrodes 21.

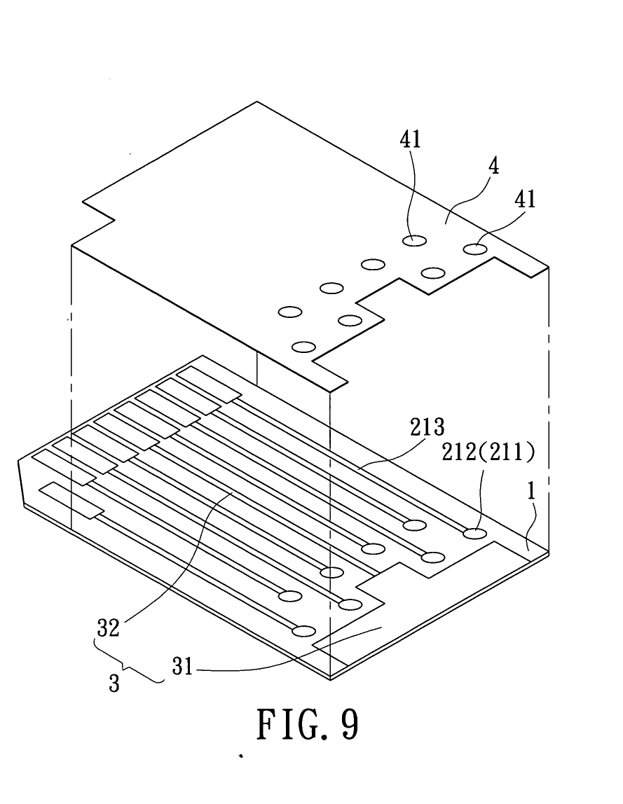

Referring to FIG. 9, the configuration of the seventh preferred embodiment of the electrochemical sensor according to this invention is similar to the second preferred embodiment, except that, in the seventh preferred embodiment, the electrochemical sensor further includes an insulating film 4 covering the conductive traces 213 of the working electrodes 21 and the reference conductive trace 32 of the reference electrode 3. The insulating film 4 is formed with through-holes 41 for exposing the sensor elements 212 of the working electrodes 21 from the insulating layer 4.

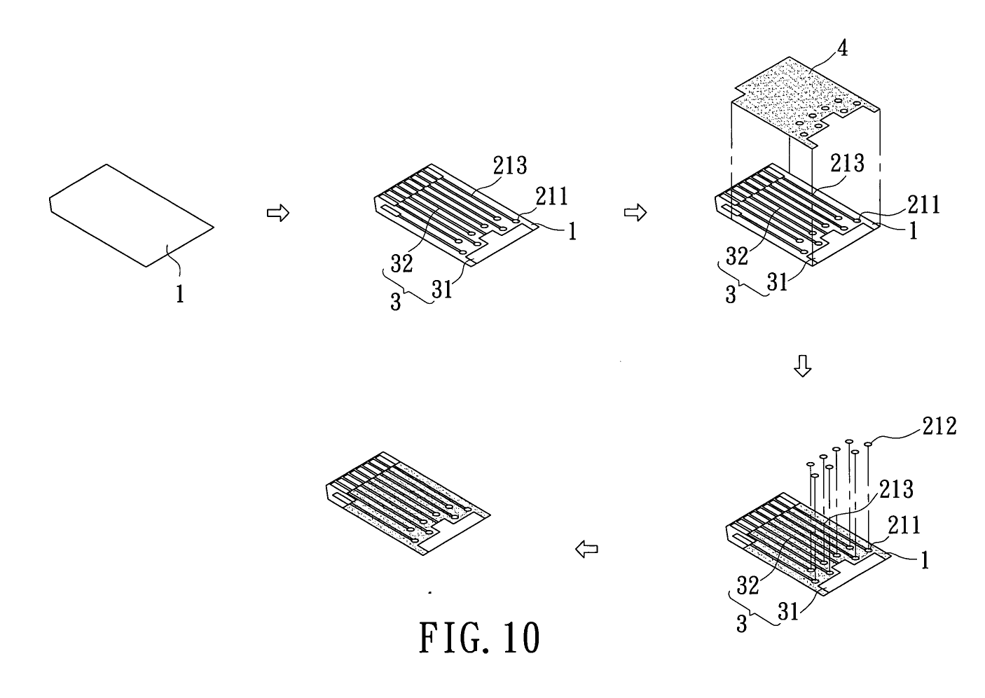

FIG. 10 shows schematic views to illustrate consecutive steps of a process of forming the seventh preferred embodiment of the electrochemical sensor according to this invention. The process includes: (1) providing the substrate 1; (2) screen-printing the conductive layered structures 211 and the conductive traces 213 of the working electrodes 21 and the reference electrode 3 on the substrate 1; (3) printing the insulating layer 4 to cover the conductive traces 213 of the working electrodes 21 and the reference conductive trace 32 of the reference electrode 3 and to expose the conductive layered structures 211 of the working electrodes 21 from the insulating layer 4; and (4) forming the sensor elements 212 on the conductive layered structures 211 using a radio frequency sputtering system so as to obtain the electrochemical sensor.

It is noted that the sensor elements 212 of the working electrodes 21 may be made from the same material or different materials depending on the actual requirements.

### Example 1

The electrochemical sensor of Example 1 has the same configuration as that of the seventh preferred embodiment. For Example 1, the substrate 1 is made from polyethylene terephthalate; each of the conductive layered structures 211 and the conductive traces 213 of the working electrodes 21 is comprised of a first layer of silver paste and a second layer of carbon paste printed on the first layer; the conductive film 31 is made from a layer of silver paste, and the reference conductive trace 32 is comprised of a first layer of silver paste and a second layer of carbon paste printed on the first layer; the insulating film 4 is made from epoxy resin; and the sensor elements 212 are made from tin oxide.

### Comparative Example 1

The electrochemical sensor of Comparative Example 1 includes a multi-ion potential sensor and the aforesaid solid-state reference electrode. The multi-ion potential sensor has a configuration differing from that of the electrochemical sensor of Example 1 in that the former is dispensed with the reference electrode 3.

### [Test]

Linearity and sensitivity of the electrochemical sensor were determined based on measured output potentials (mV) in response to different predetermined pH values of the buffer solutions, in which the sensitivity is calculated using the following equation:

Sensitivity (mV/pH)=(the highest output potential−the lowest output potential)/(the highest pH value−the lowest pH value)

### (Test 1) Linearity and Sensitivity Determined Using Only One Sensor Element in Each pH Measurement

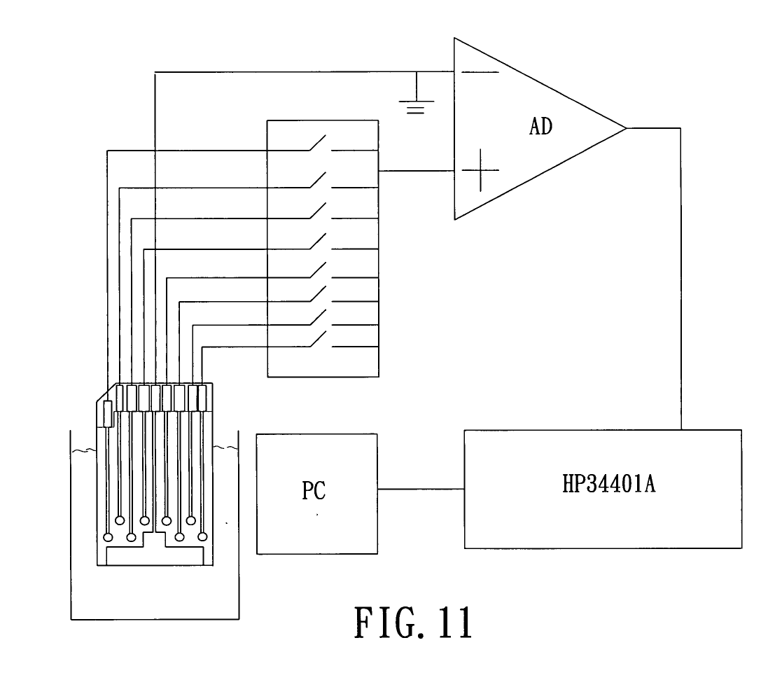

Referring to FIG. 11, the variation of the output potential of the electrochemical sensor of Example 1 with respect to buffer solutions having pH value that range from 2 to 12 was measured. In the test 1, only one of the sensor elements 212 was used, the reference conductive trace 32 of the reference electrode 3 was connected to the negative input end (−) of an instrumentation amplifier AD, and one of the conductive traces 213 corresponding to the selected one of the sensor elements 212 of the working electrodes 21 was connected to the positive input end (+) of the instrumentation amplifier AD. The potential signals collected from the instrumentation amplifier AD were transmitted to and were converted through a digital measuring system HP34401A into digital signals for calculation of the linearity and the sensitivity of the selected sensor element 212 through a computer (PC).

The results of the linearity and the sensitivity of the electrochemical sensor using one sensor element 212 over the pH values ranging from 2 to 12 are listed in Table 1.

### (Test 2) Linearity and Sensitivity Determined Using Four Sensor Elements in Each pH Measurement

The measurement of the linearity and the sensitivity in Test 2 is similar to that in Test 1, except that, in Test 2, the number of the sensor elements 212 used in each pH measurement was four, and the conductive traces 213 corresponding to the four selected ones of the sensor elements 212 of the working electrodes 21 were electrically connected to the positive input ends (+) of four instrumentation amplifiers AD. The potential signals collected from the instrumentation amplifiers AD were processed by an adder so as to generate output signals, which were transmitted to and were converted through the digital measuring system HP34401A into digital signals for calculation of the linearity and the sensitivity of the selected sensor elements 212 through the computer. The results of the linearity and the sensitivity of the electrochemical sensor using four sensor elements 212 over the pH values ranging from 2 to 12 are listed in Table 1.

### (Test 3) Linearity and Sensitivity Determined Using Eight Sensor Elements in Each pH Measurement

The measurement of the linearity and the sensitivity in Test 3 is similar to that in Test 2, except that, in Test 3, the number of the sensor elements 212 used in each pH measurement was eight. The results of the linearity and the sensitivity of the electrochemical sensor using eight sensor elements 212 over the pH values ranging from 2 to 12 are listed in Table 1.

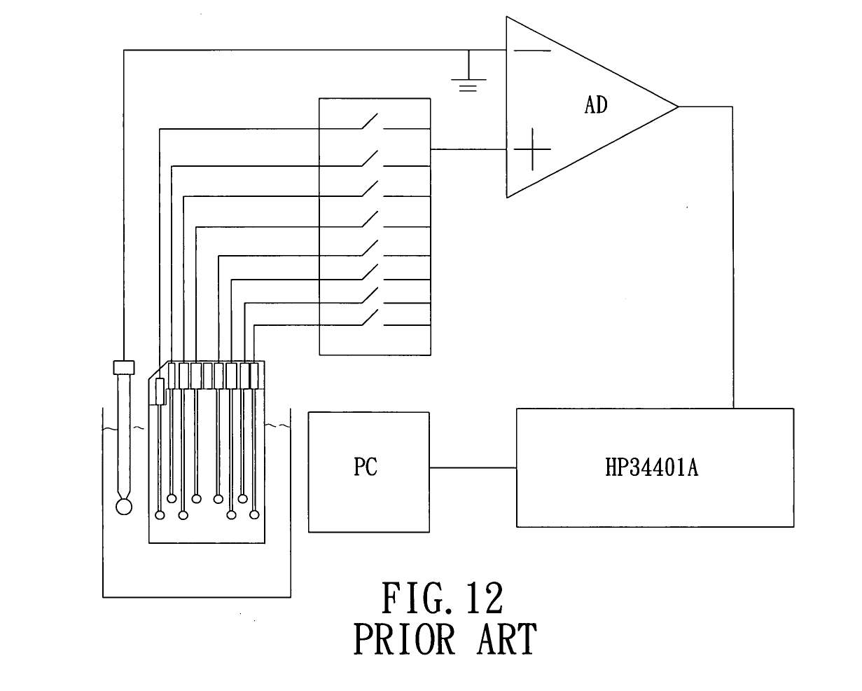

Referring to FIG. 12, the measurements of the linearity and the sensitivity in Tests 1˜3 for the Comparative Example are similar to those in Tests 1˜3 for Example 1. The results of the linearity and the sensitivity of the electrochemical sensor for each of the Tests 1˜3 for the Comparative Example are also listed in Table 1.

TABLE 1

| | | | Sensitivity |
|---|---|---|---|
| | Test No. | Linearity | (mV/pH) |
| Comparative | 1 | 0.9637 | 36.30 |
| Example | 2 | 0.9922 | 54.03 |
| | 3 | 0.9671 | 22.20 |
| Example 1 | 1 | 0.9335 | 54.03 |
| | 2 | 0.9713 | 42.40 |
| | 3 | 0.9669 | 41.30 |

The results shown in Table 1 indicate that the electrochemical sensor of this invention can significantly improve the sensitivity as compared to the conventional electrochemical system.

While the present invention has been described in connection with what are considered the most practical and preferred embodiments, it is understood that this invention is not limited to the disclosed embodiments but is intended to cover various arrangements included within the spirit and scope of the broadest interpretation and equivalent arrangements.

What is claimed is:

1. An electrochemical sensor for detecting the concentration of ions in a solution, comprising:
a substrate;
a sensor unit including at least one working electrode having a conductive layered structure formed on said substrate and a sensor element of a metal oxide film formed on said conductive layered structure and capable of reacting with the ions in the solution to generate a potential; and
a reference electrode spaced apart from said working electrode and including a conductive film printed on said substrate for establishing a potential difference between said working electrode and said reference electrode when said electrochemical sensor is brought into contact with the solution.

2. The electrochemical sensor of claim 1, wherein said conductive film is made from silver paste.

3. The electrochemical sensor of claim 1, wherein said conductive layered structure includes a layer of silver paste.

4. The electrochemical sensor of claim 1, wherein said conductive layered structure includes a first layer of silver paste printed on said substrate, and a second layer of carbon paste printed on said first layer, said sensor element being formed on said second layer.

5. The electrochemical sensor of claim 1, wherein said metal oxide is tin oxide.

6. The electrochemical sensor of claim 1, wherein said sensor unit includes a plurality of said working electrodes, said conductive film of said reference electrode being bar-like in shape and extending in a direction, said sensor elements of said working electrodes being disposed adjacent to said conductive film and being distributed along the direction.

7. The electrochemical sensor of claim 1, wherein said sensor unit includes a plurality of said working electrodes, said conductive film of said reference electrode being circular in shape, said sensor elements of said working electrodes being disposed adjacent to said conductive film and being angularly displaced from one another to surround said conductive film.

8. The electrochemical sensor of claim 1, wherein said sensor unit includes a plurality of said working electrodes, said conductive film of said reference electrode being circular in shape and being formed with a plurality of inner spaces that are angularly displaced from one another, said sensor elements of said working electrodes being disposed in said inner spaces in said conductive film.

9. The electrochemical sensor of claim 1, wherein said sensor unit includes a plurality of said working electrodes, said conductive film of said reference electrode being arch-like in shape, said sensor elements of said working electrodes being disposed adjacent to said conductive film and being angularly displaced from one another.
